(19) United States
(12) Patent Application Publication
(10) Pub. No.: US 2002/0134452 A1
(43) Pub. Date: Sep. 26, 2002

(54) Methods of girth welding high strength steel pipes to achieve pipeling crack arrestability

(76) Inventors: Douglas P. Fairchild, Sugar Land, TX (US); Clifford W. Petersen, Missouri City, TX (US); Scott D. Papka, Sugar Land, TX (US); Mario L. Macia, Bellaire, TX (US)

Correspondence Address: Marcy M. Hoefling, ExxonMobil Upstream Research Company, P.O. Box 2189, Houston, TX, 77252-2189, US

(21) Appl. No.: 10/100,552

(22) Filed: Mar. 18, 2002

Related U.S. Application Data
(60) Provisional application No. 60/277,544, filed on Mar. 21, 2001.

(51) Int. Cl. F16L 9/22

(52) U.S. Cl. 138/155; 285/288.1; 138/172

(57) ABSTRACT

Girth welds with crack arresting capability, and welding methods for producing same in high strength pipelines, are provided. Girth welds according to this invention are produced in high strength pipelines by welding methods that produce (i) HAZ microstructures that are softer than the pipeline steels, (ii) weld toes that act as stress/strain concentrators, thus promoting tearing in the HAZ and a ring-off fracture; and (iii) a weld geometry that promotes an inclined fracture path.

This application claims the benefit of U.S. Provisional Application No. 60/277,544, filed Mar. 21, 2001.

### FIELD OF THE INVENTION

This invention relates to girth welding of high strength steel pipes to form pipelines with crack arrestability. More particularly, this invention relates to methods for producing girth welds capable of arresting crack propagation. This invention also relates to girth welds produced by such methods.

### BACKGROUND OF THE INVENTION

Various terms are defined in the following specification. For convenience, a Glossary of terms is provided herein, immediately preceding the claims.

A significant risk associated with a gas transmission pipeline is that of rupture and subsequent propagation of a running ductile fracture. In such instances, the running ductile fracture, driven by the energy associated with the contained gas pressure, can propagate for distances of up to many miles until the crack encounters pipe with sufficient intrinsic fracture propagation resistance or it encounters some other significant barrier to propagation. A term commonly used to describe barriers to propagation is “crack arrestor”. Crack arrestors can be of a manufactured type—e.g. a section of pipe with a thicker wall than the pipe to which it is connected or a section of pipe having an encircling ring of steel or other material. Also, other obstacles such as a road crossing or a bend in the pipe can act as a crack arrestor.

Within the last 10 years, advanced steel making techniques have enabled the manufacture of ever stronger grades of steel pipe. Grades such as X80, X100, and higher are being considered for new pipeline construction. With this increase in steel strength comes an increase in operating pressure and a higher driving force to propagate a running ductile fracture. Therefore, pipeline designs that include the use of higher strength pipe (say, X80 and above) are in need of suitable crack arrest technology.

Virtually all modem gas transmission pipelines are composed of sections of pipe, approximately 12 meters (40 feet) in length, that are joined together by girth welds. Typical pipeline designs do not depend on the girth welds to offer any inherent resistance to the propagation of a running ductile crack.

Girth Weld Regions

From a metallurgical standpoint, a girth weld can be separated into several regions. A schematic of a girth weld cross section is shown in FIG. 1. The weld metal 10 is the region that was rendered molten during the welding operation. Weld metal 10 is comprised of both melted base metal from the steel pipes being joined by the weld and welding consumable (typically a wire or electrode). The heat-affected zone (HAZ) 12 is the region of base metal directly adjacent to the weld metal whose metallurgical structure has been altered by the heat from welding. The unaffected base metal 14 is the region of the pipe body adjacent to the HAZ 12 that was unaffected by the heat from welding.

Although it might be ideal if girth welds were homogeneous in microstructure and properties, this is almost never the case. Each of the areas identified in FIG. 1 possesses a unique microstructure (or unique mix of microstructures) and its own set of mechanical properties. The properties of weld metal 10 and of HAZ 12 are dependent on local chemistry and the weld thermal cycle. Because the chemistry and thermal cycle can change in increments as small as from millimeter to millimeter, weld metals, such as weld metal 10, and HAZ's, such as HAZ 12, tend to be inhomogeneous.

Relative Properties in Lower Grade Pipe: Base Metal versus Girth Weld

Pipelines built from pipe grades up to about X70, typically have girth welds, including both the weld metal and HAZ, that are stronger than the steel pipes being joined by the weld. This is a function of the steel pipe chemistry and processing condition relative to commonly applied welding techniques. For the steel pipe to meet the required strength properties in pipe grades up to about X70, only moderate carbon and manganese contents are necessary (with possibly small amounts of a few other alloys like Si, Cu, and Ni) to produce the desired ferrite-pearlite microstructure. Thermo-mechanical control processing (TMCP) treatments that involve rolling just above or below the Ar₃ temperature, and/or accelerated cooling to low temperatures are not necessary to achieve the required strengths in low grade pipe.

A significant factor that contributes to the relatively high strength (compared to the base pipe) of girth welds in lower grade pipelines, is the weld cooling rate. Field pipeline welds are typically made with the steel pipe stationary, thus requiring that the welding technique be suitable for all positions; flat, vertical, and overhead. These demands restrict the welding heat input to relatively low levels (less than about 1.5 kJ/mm), and this creates a rapid thermal cycle. In response to a fast cooling rate, the HAZ typically forms harder transformation products as compared to the ferrite-pearlite structure of the unaffected base metal. Therefore, lower grade pipelines often contain HAZ's with harder, stronger microstructures than the steel pipe.

Rapid thermal cycles also contribute to strong weld metals, however, there is an additional factor related to chemistry and microstructure that affects weld metal strength. The microstructure of choice for weld metals in lower grade steel pipes is acicular ferrite. This product is desired due to its fine grain size, high toughness, and good strength. Producing acicular ferrite often requires a modified alloy content compared to the base metal, most notably an addition of Ti is necessary. When subjected to the cooling rates typical for pipeline welding, acicular ferrite produces tensile strengths in the range of 483 to 621 MPa (70 to 90 ksi). It is, therefore, quite easy for the weld metal in a lower grade steel pipe to “overmatch” base metal strength.

Ductile Fracture Propagation in Low Strength Pipelines

For the purpose of this discussion, the term “low strength steel pipeline” refers to a pipeline constructed from a plurality of steel pipes of grade X70 or lower, as known to those skilled in the art. As illustrated in FIG. 2A, during propagation of a running ductile fracture in a pipeline made up of low strength steel pipes 24 and 24′ joined by girth weld 26, a large plastic zone 20 travels in front of crack tip 22. In contrast to static cracks in structural steels, where crack tip plastic zones are on the order of a few millimeters, plastic zone 20 in a running ductile fracture can be many inches in “diameter” (perhaps one foot or slightly larger). Within the large plastic zone 20, the material is subjected to plastic strains of up to 15-20%. A large component of the plastic straining is oriented longitudinally; i.e., parallel to the axes of pipes 24 and 24′. Much of the longitudinal strain is due to the “flaps” 25, as known to those skilled in the art, that form on either side of the running crack and within a couple of pipe diameters of the crack tip. These flaps are pushed open by the escaping gas 28.

Referring now to FIG. 2B, when the plastic zone 20 of a running ductile fracture encounters a typical girth weld 26, i.e., a girth weld that contains a HAZ and weld metal that are stronger than the base pipes 24 and 24′, the girth weld 26 plastically deforms no more than the base pipe 24. Unless significant weld defects are present, or the weld is too brittle (explained below), the girth weld 26 will withstand the plastic strain without failure, and allow the running crack to pass through and enter the next pipe 24′. In other words, when the weld metal and HAZ of girth weld 26 are as strong, or stronger, than the base pipes 24 and 24′, a running ductile fracture will travel along a pipeline through numerous pipes such as 24 and 24′ unimpeded by girth welds 26.

Under certain circumstances, during a running ductile fracture in a low strength steel pipeline, girth welds can fail prematurely, just before the ductile fracture arrives. Referring to FIGS. 3A and 3B, if girth weld 35 contains defects, or other significant stress concentrations, and/or if the weld metal is too brittle, then the plastic zone ahead of the running ductile fracture crack tip 31 (primarily the longitudinal strains) can cause secondary cracking in the weld metal before the running crack tip 31 arrives. Such a secondary crack 37 can propagate around the circumference along girth weld 35. The phenomena of an axial crack suddenly leading to a circumferential fracture of the pipeline is known to those skilled in the art as “ring-off” fracture. When a ring-off fracture initiates ahead of a primary crack tip 31 propagating through pipe 33, then once the primary crack tip 31 arrives at the girth weld 35, it encounters the free surfaces of the secondary crack 37, and it will not transfer through girth weld 35 and into the next pipe 33′. Therefore, girth weld 35 acts as a crack arrestor.

The type of ring-off fracture shown in FIGS. 3A and 3B has been discussed in “Girth Weld Crack Arrestor Investigation to Northern Engineering Services Company, Limited”, R. J. Eiber and W. A. Maxey, Battelle Columbus Laboratories, Nov. 15, 1974. This report concludes that for girth welds to act as ring-off crack arrestors the following conditions are anticipated to be necessary (although these conditions were not proven):

1. The girth weld should have relatively low dynamic toughness and a high dynamic transition temperature.

2. The girth weld should contain small flaws in the weld root which act as stress concentrators. Notionally, these flaws may be acceptable per common pipeline fabrication requirements (e.g. API 1104)

3. The primary running ductile crack should travel at a relatively slow speed so that the flaps apply large longitudinal plastic strains to the girth weld.

Although the above items were noted in the early to mid 1970's, to the knowledge of the inventors of the current invention, this information has never been used to design a pipeline whereby the girth welds were depended upon for crack arrestors. This type of crack arrest philosophy has not been used for several reasons. First, designing an arrestor according to the above items would mean that low toughness welds containing defects would purposefully be introduced into a pipeline. Creating weld toughness that is suitably low and weld defects that are suitably small to meet this requirement, yet acceptable for pipeline service, is impractical. This strategy creates too much risk of in-service girth weld failure. In contrast to making welds of lesser integrity, the opposite trend has occurred over the last 25 years; i.e., much effort has been expended to produce high toughness welds and low defect rates. Another reason why girth welds have not been depended upon as crack arrestors is that steel makers have been able to produce high toughness pipe steels (referring to lower strength grades, such as X70 and below) that are typically capable of intrinsic crack arrest under demanding applications. When such pipes are used for pipeline construction, crack arresting girth welds are not needed.

Heretofore, crack arresting girth welds have not been utilized for any known pipelines and, therefore, crack arrest by any girth weld in an actual pipeline would have occurred by chance. The object of the current invention is to provide methods for producing a girth weld for joining high strength steel pipes that intrinsically arrests a propagating crack.

### SUMMARY OF THE INVENTION

The inventors have discovered methods to make girth welds in high strength steel pipe (grades X80 and higher) such that these welds will act as crack arrestors in the event of a running ductile fracture. High strength steels obtain much of their strength from the presence of dislocations. The heat from any welding process can “undo” this strengthening mechanism. Therefore, in high strength steels, it is possible to create microstructures in a weld heat-affected zone (HAZ) that are softer than either the base pipe or the weld metal. Soft HAZ microstructures in combination with certain geometrical features of the weld can be used to create a girth weld that will arrest a running ductile fracture while still being suitable for normal pipeline service.

The inventors have discovered that a girth weld that connects first and second high strength steel pipes and has the following features in combination acts as a crack arrestor: (i) a HAZ comprising one or more microstructures with hardness values that are lower than the average hardness values of the base metal and weld metal of said first and second high strength steel pipes; (ii) one or more weld toes in contact with said HAZ; and (iii) a weld geometry such that the angle between the general weld fusion line and the inside surface of the pipe wall is less than 90°, all such that upon the approach of a crack tip that is propagating through said first high strength steel pipe a ring-off fracture will propagate around the circumference of said first high strength steel pipe along said girth weld. Based on these discoveries, the inventors now provide girth welds capable of arresting crack propagation through a high strength steel pipeline, and methods for producing such girth welds.

### DESCRIPTION OF THE DRAWINGS

The advantages of the present invention will be better understood by referring to the following detailed description and the attached drawings in which:

FIG. 1 (PRIOR ART) is a schematic illustration of a girth weld cross section;

FIG. 2A (PRIOR ART) is a schematic illustration of a running ductile fracture in a pipeline, shown prior to encountering a girth weld;

FIG. 2B (PRIOR ART) is a schematic illustration of a running ductile fracture in a pipeline, shown passing through a girth weld;

FIGS. 3A and 3B (PRIOR ART) schematically illustrate the initiation stage of a ring-off fracture in a brittle weld metal;

FIGS. 4A and 4B schematically illustrate microhardness traverses on a girth weld cross section;

FIG. 4C is a graph of microhardness values of the indents shown in FIGS. 4A and 4B; the Y-axis 40 represents Vickers Hardness and the X-axis 41 represents distance;

FIGS. 5A and 5B schematically illustrate the initiation stage of a ring-off fracture in a girth weld in a high strength steel;

FIGS. 6A and 6B schematically illustrate Mode III crack opening forces that can occur during a ring-off fracture;

FIG. 7 is a schematic illustration of a cross section of a ductile fracture path in steel;

FIG. 8 is an etched cross section of a CRC-type mechanized girth weld;

FIG. 9 is a schematic illustration of a cross section of a girth weld geometry that produces HAZs inclined at 45° to the interior pipe surface;

FIG. 10 is a schematic illustration of a cross section of a preferred girth weld geometry according to this invention;

FIG. 11A is the schematic illustration shown in FIG. 10, but showing greater detail about the HAZ;

FIG. 11B is the schematic illustration shown in FIG. 11A, which also shows the likely fracture path for a ring-off fracture;

FIG. 12A is a schematic illustration of a cross section of the mechanized girth weld shown in FIG. 8;

FIG. 12B is the schematic illustration of FIG. 12A, but showing a likely ring-off fracture path;

FIGS. 13A, 13B, and 13C schematically illustrate a comparison of the girth welds produced by various welding processes;

FIG. 14A is a schematic illustration of a cross section of a double-jointed girth weld produced by the submerged arc welding process; and

FIG. 14B is the schematic illustration of FIG. 14A, which also shows the likely fracture path for a ring-off fracture.

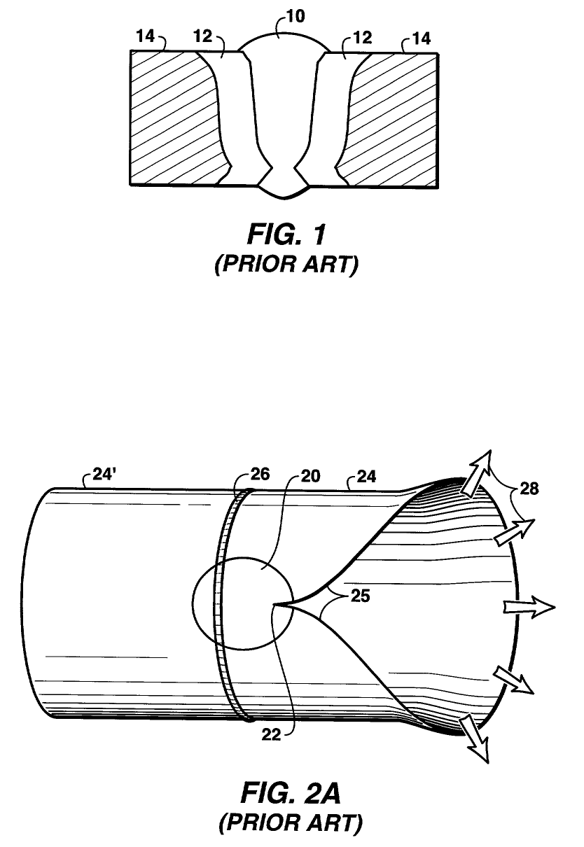

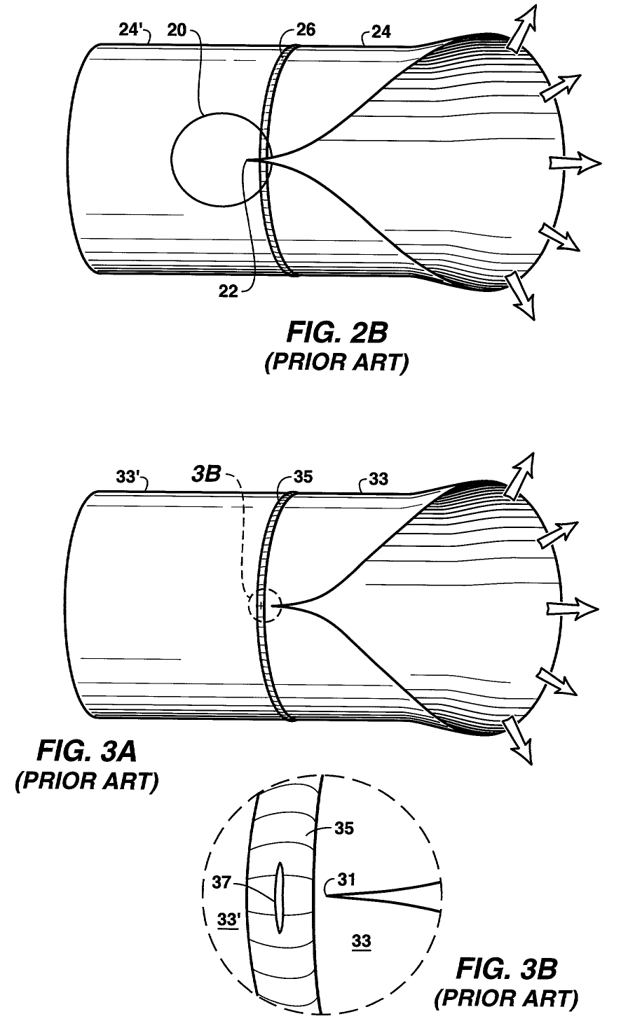

While the invention will be described in connection with its preferred embodiments, it will be understood that the invention is not limited thereto. On the contrary, the invention is intended to cover all alternatives, modifications, and equivalents which may be included within the spirit and scope of the present disclosure, as defined by the appended claims.

### DETAILED DESCRIPTION OF THE INVENTION

As noted in the Background, the Eiber and Maxey concept for creating a crack arresting girth weld includes limiting weld toughness and utilizes the presence of weld defects. In contrast, the current invention does not apply these means because, generally, they reduce pipeline integrity. It is also important to note that the current invention takes advantage of a particular feature of high strength steels (dislocation strengthening) and does not necessarily apply to lower strength grades such as X70 and below. In the following discussion, the term “high strength steel pipeline” refers to a pipeline constructed from a plurality of steel pipes having yield strengths of about 550 MPa (80 ksi) or greater, as measured by any standard technique known to those skilled in the art. A detailed description of a crack arresting girth weld, according to the current invention, is best prefaced by explaining the nature of weld heat-affected zones and running ductile cracks in high strength steel pipelines.

Relative Properties in High Strength Pipe: Base Metal versus Girth Weld

For high strength steel pipelines, additional steel making measures are necessary, as compared to lower grades, in order to achieve the required strength. The alloy content may increase, and/or TMCP treatments may be used. As a result, the microstructure of higher grade steel pipes obtains a greater portion of its strength from the presence of dislocations as compared to lower strength steel pipes. As is known to those skilled in the art, a dislocation is a linear imperfection in a crystalline array of atoms. The dislocations can be induced through rolling deformation or they can be related to microstructural transformations. Bainite and martensite are two prime examples of microstructures that achieve a significant portion of their strength from a high dislocation density. Dislocation strengthening typically increases as the steel pipe grade increases.

Weld metals in high strength steel pipes can be produced with tensile strengths of up to about 966 MPa (140 ksi), or somewhat higher, depending on the toughness requirements and other factors, as will be familiar to those skilled in the art. Therefore, there is generally no difficulty in matching weld metal to pipe strength in high strength steel pipelines. HAZ's, however, can be an area of local softening in high strength steel pipes. HAZ thermal cycles in high strength steel pipes typically cause complete reaustenization in the microstructure near the fusion line and dislocation recovery further away from the fusion line. Both of these phenomena can “undo” the dislocation strengthening that was imparted to the original base metal.

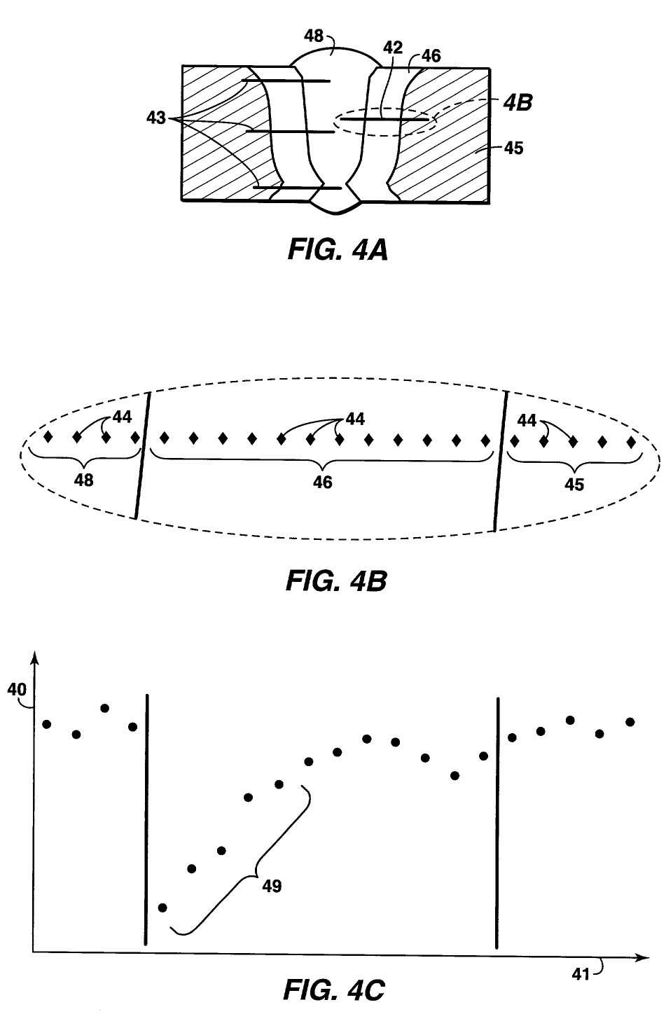

For the purposes of this invention, a HAZ that is described as being “soft” will contain at least one macroscopic region having a hardness value that is lower than the average hardness value of the base metal on one side of the HAZ and is lower than the average hardness value of the weld metal on the other side of the HAZ, each of said hardness values being measured by the same technique. Typically, the width of any such macroscopic region in a soft HAZ will be significant on a macroscopic scale; i.e. will be large enough to be perceived without magnifying instruments. Typically, any such microstructural region will have a width greater than about 1 mm. The degree of HAZ softening in a weld can be quantified by utilizing a microhardness measurement technique such as the Vickers method to produce, what is known to those skilled in the art, as a microhardness traverse. Such a hardness traverse, as applied to a weld, is illustrated by FIGS. 4A, 4B, and 4C. In FIG. 4C, the Y-axis 40 represents Vickers Hardness and the X-axis 41 represents distance. Referring to FIGS. 4A and 4B, generally, a traverse consists of numerous microhardness indents, such as indents 44, positioned along a “line” 42 that crosses (i.e., traverses) the weld metal 48, HAZ 46, and base metal 45. By producing a graph of the microhardness values as shown in FIG. 4C, the relative hardnesses of these regions can be compared. Considering the microhardness traverse shown in FIG. 4C, the average hardness of the weld metal 48 would be calculated by adding together the hardness values associated with the indents 44 placed in the weld metal 48, and dividing by the number of said weld metal indents. Likewise, the average hardness of the base metal 45 would be calculated by adding together the hardness values associated with indents 44 placed in the base metal 45, and dividing by the number of said base metal indents. In a soft macroscopic region within HAZ 46, the majority of the hardness values 49 (FIG. 4C) associated with the indents 44 placed in said soft region will be lower than the average hardness of the base metal 45 or weld metal 48.

To achieve suitable accuracy and resolution in a HAZ microhardness traverse in steel, the indents 44 should be relatively close together and the applied load should be suitably small. The indents 44 should not be so far apart that any soft macroscopic region would be undetected. The indents 44 should be no closer to each other than about two or three times the width of any single indent 44. The applied load to be used for any single indent 44 should be about 1 kg or less. A HAZ microhardness traverse should begin with several indents in the weld metal 48 and end with several indents in unaffected base metal 45. To fully understand the degree of HAZ softening in any single weld, it is typically beneficial to conduct more than one traverse whereby each traverse is at a different location between the surfaces of the cross section; see 43 in FIG. 4A. This method can account for differences in local microstructure and welding heat flow.

The above description of a HAZ microhardness traverse is meant to be typical. Variations of the above or other means to quantify hardness can be used. Any measurement technique is suitable as long as it provides the user with an indication of the hardness of the various sub-regions within a HAZ.

Ductile Fracture Propagation in High Strength Pipelines

Consider the case in a high strength steel pipeline where the various regions of each girth weld (weld metal, base metal, and HAZ) possess the same relative strength properties as would be typical for a lower grade pipeline. In other words, the weld metal and HAZ regions are, generally, as strong, or stronger, than the base metal. In such a case, the behavior of a running ductile fracture as it encounters each girth weld will be the same as in a lower grade pipeline. Generally, the crack will advance from pipe to pipe, unimpeded by the girth welds.

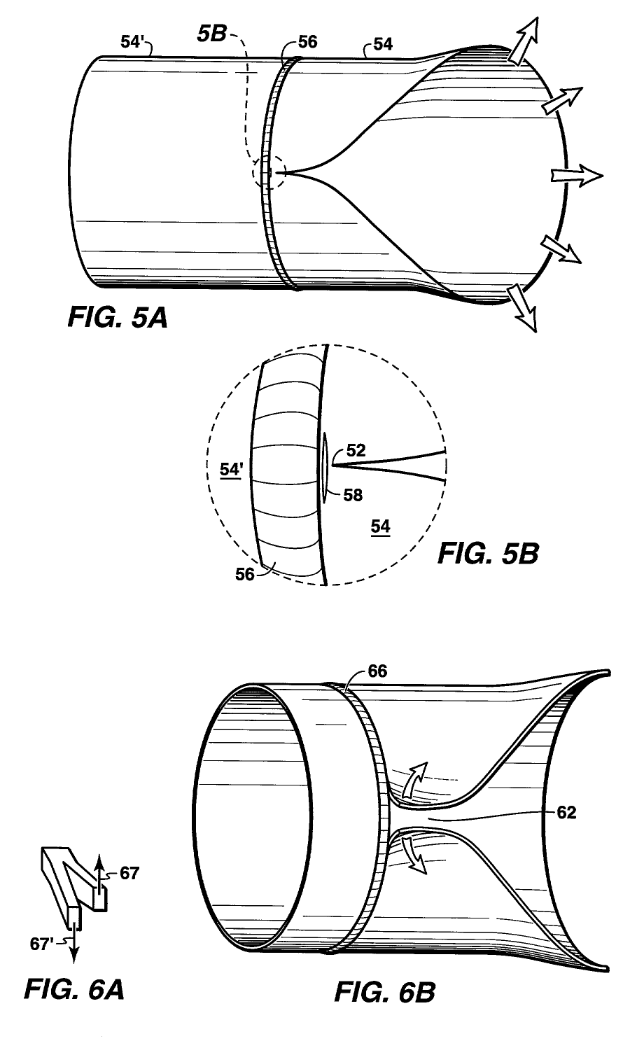

If, however, the girth welds in a high strength steel pipeline are made consistent with the guidelines of the current invention, then the girth welds can act as crack arrestors. A schematic diagram of a crack arresting girth weld is shown in FIGS. 5A and 5B. In this weld, certain material and geometric properties have been manipulated to create a local mismatch in plastic flow. Referring to FIGS. 5A and 5B, in steel pipe 54, having a grade of X80 or higher, any mismatch in plastic flow (deformation properties) that is present within the plastic zone of a running ductile fracture can lead to a secondary ductile tear (crack). This irregular plastic flow can be caused by the presence of locally soft material, i.e., a HAZ, and/or by geometric factors as will be explained below. If sufficient “weaknesses” are present in a high strength steel girth weld, such as girth weld 56, the plastic zone (primarily the longitudinal strains) ahead of a running ductile fracture crack tip 52 can cause secondary cracking in or near girth weld 56, before the running crack tip 52 arrives. Such a secondary crack 58 can propagate around the circumference of pipe 54 along girth weld 56. As mentioned earlier, this phenomena is known to those skilled in the art as “ring-off” fracture and the creation of free surfaces ahead of the primary fracture can produce crack arrest.

Referring to FIGS. 6A and 6B, the inventors have discovered that the bulging that occurs in area 62 at the tip of a crack propagating through a pipeline, and the flap movement that occurs at the breach opening creates an additional driving force for ring-off fracture (additive to the longitudinal stresses) that peels open the pipe in crack opening geometry known to those skilled in the art as Mode III. The inventors believe that the longitudinal strains in the plastic zone are primarily responsible for initiating ring-off fracture, whereas the Mode III crack opening strains 67 and 67′ mainly assist in propagating the ring-off fracture around the circumference.

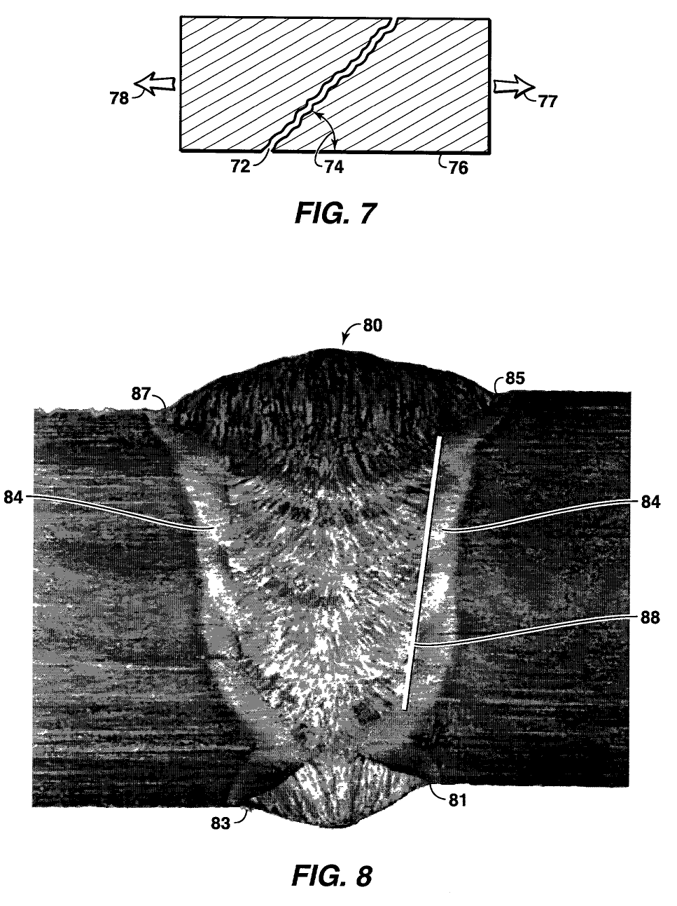

One characteristic of ductile fractures in steel that will be utilized by the guidelines given below is the geometry of the tearing path. Ductile fracture paths in steel typically occur at a characteristic angle to the surface of the material. Most often this angle is about 45°, as illustrated by FIG. 7, in which fracture path 72 is shown at an angle 74 of about 45° to the surface 76 of the material that is fracturing. In FIG. 7, the directions of principle strain 77 and 78 are shown.

Guidelines for Producing a Crack Arresting Girth Weld in High Strength Steel Pipelines

A key factor in producing a girth weld according to this invention that will ring-off and arrest a running ductile fracture, yet be suitable for typical pipeline service, is to create features in the weld that promote a convenient inclined fracture path. Such a design exacerbates the natural tendency of the material to fail along a path that is at an angle of about 45° to the surface of the material that is failing. The current invention utilizes three features to produce a convenient inclined fracture path in a high strength steel pipeline girth weld; (1) the presence of soft material, i.e., the HAZ, (2) stress/strain concentrations, i.e., one or more weld toes, (3) the geometrical positioning of the first two items such that they promote an inclined fracture path through a significant portion of the HAZ.

It is the intent of the current invention, to use the HAZ in a high strength steel pipeline girth weld as suitable soft material for crack arresting purposes. The entire HAZ does not have to be soft in order to be defined as such according to the current invention. As discussed earlier, only a portion of the HAZ needs to be soft in order to perform as a crack arresting girth weld. High strength steel microstructures have significant dislocation strengthening, and welding these steels can “undo” the dislocation strengthening, thus creating HAZ material that is softer than either the base metal or weld metal. Higher heat inputs maintain the HAZ at higher temperatures for longer times and this can either re-transform the original microstructure or cause significant dislocation recovery, both of which will result in softening. Therefore, higher heat inputs create wider and softer HAZs and this promotes ring-off fracture and crack arrest. Suitably soft HAZ's can be created as long as the welding heat input is high enough to undo the dislocation strengthening. Generally, for the arc welding processes, welding heat inputs above about 0.5 kJ/mm will be satisfactory to create a suitably soft HAZ.

Another crack arresting aspect of a soft weld HAZ is that it typically extends through substantially the entire pipe wall thickness, thus creating a weakened path of significant dimensions. Any weld design that disrupts the tendency of the HAZ to extend through the entire pipe wall thickness would not be a desired feature of the current invention.

To produce a convenient circumferential path for a ring-off fracture according to the current invention, it is important to have stress raising weld toes in direct contact with the HAZ. In conventional welded joints, the weld toe is defined as the region on the surface of the weldment at the transition point between the weld metal and the base metal or alternatively as the exposed surface of the fusion interface at the welded joint. For purposes of this specification and the appended claims, a weld toe includes any exposed fusion interface, whether at the weld cap or the root of the weld, including any weld toe that is subsequently covered by another weld. In a girth weld, these points exist at both the internal (root) surfaces and external (cap) surfaces of the pipe. The weld toe is known to be a point of stress concentration due to both geometrical discontinuity and residual stresses from the thermal cycles of the welding process. This makes the weld toe a likely site for fracture initiation. FIG. 8 shows an etched cross section of a CRC-type mechanized girth weld 80 with weld toes 81 and 83 located at the internal (root) surfaces of the steel pipes being joined, and weld toes 85 and 87 located at the external (cap) surfaces of the steel pipes being joined. When the plastic zone of a running ductile fracture arrives at a girth weld, such as girth weld 80, weld toes 81, 83, 85, and 87, produce stress/strain concentrations that promote tearing in HAZ 84. These stress/strain concentrations are particularly effective because weld toes 81, 83, 85, and 87, by definition, are in direct contact with HAZ 84. Weld toes that have either been removed intentionally by machining or grinding, or that are smooth due to the welding procedure used to make the weld, are not desired features of the current invention.

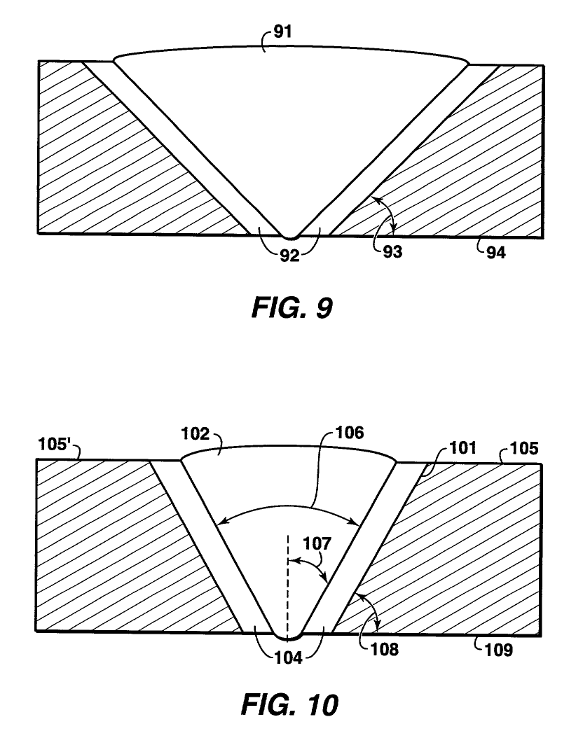

It is the intent of the current invention to position soft material (i.e., HAZ) and stress concentrations (i.e., weld toes) along a convenient inclined fracture path so as to promote the occurrence of ring-off fracture. A path at an angle of about 45° to the internal surface of the steel pipe being welded is preferred because it exacerbates the natural failure mode of the material. Although a 45° HAZ geometry is preferred, there are economic considerations that make a geometry of exactly 45° impractical. If a girth weld were produced with a HAZ inclined at 45° to the pipe wall, then the cross section would appear as shown in FIG. 9, which shows HAZ 92 adjacent weld metal 91 an angle 93 of about 45° to internal surface 94 of a steel pipe being welded. The weld schematics shown in FIGS. 9, 10, 11A and 11B do not show the outline of individual weld passes; however, FIGS. 9, 10, 11A and 11B are intended to represent multipass welds. The weld illustrated in FIG. 9 would require an extremely “open” bevel and it would take too much time and welding consumable to produce to be considered economically practical, as will be appreciated by those skilled in the art.

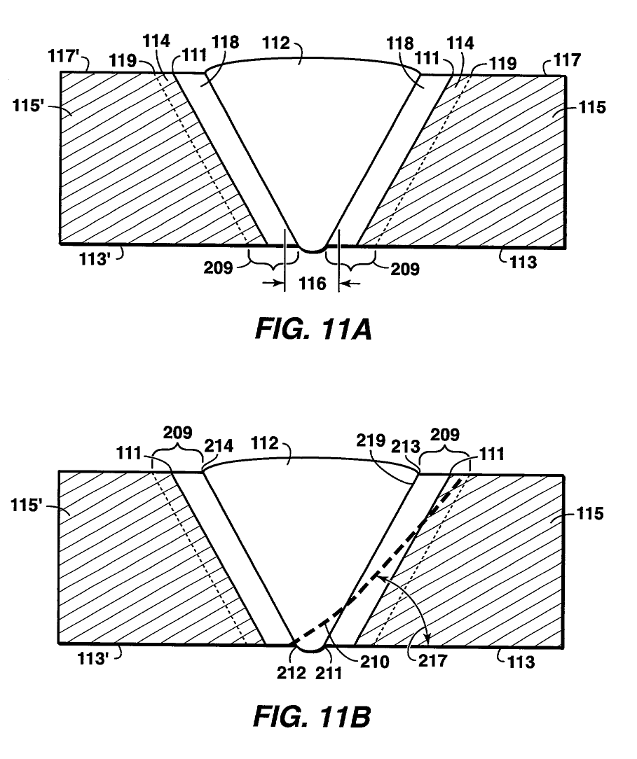

A preferred pipeline weld geometry for this invention that suitably combines a soft HAZ and weld toe stress concentrations into a convenient inclined fracture path is shown schematically in FIG. 10, which shows weld metal 102, with HAZ 104, joining pipes 105 and 105′. As illustrated, weld metal 102 has an included angle 106 of about 60° (and a lesser included angle 107 of about 30°). The weld illustrated in FIG. 10 also shows an angle 108 of about 60° between the outer boundary 101 of HAZ 104 and the interior surface 109 of pipe 105. FIG. 11A highlights two items that make the weld illustrated in FIG. 10 a preferred weld according to this invention. The first item is that for steels with significant dislocation strengthening, weld related softening extends beyond the etched HAZ boundary, as is familiar to those skilled in the art. FIG. 11A illustrates etched HAZ boundaries 111 and boundaries 119 that indicate the extent of softening. The boundaries 119 separate the base metal of pipes 115 and 115′ from the softened material 114. The combination of the etched HAZ 118 and the softened material 114 will be referred to as the composite HAZ 209. The second item, also illustrated in FIG. 11A, involves the width 116 of weld metal 112 adjacent the internal surfaces 113, 113′ of pipes 115, 115′. At this location, weld metal 112 is narrow as compared to the width of weld metal 112 adjacent the external surfaces 117, 117′ of pipes 115, 115′; and this allows the composite HAZs 209 on either side of weld metal 112 to be in relatively close proximity. Referring now to FIG. 11B, when the composite HAZ 209 and narrow dimension 116 (shown in FIG. 11A) are combined with the weld toe stress concentration effect, then a convenient, inclined tearing path 210 oriented at an angle 217 of about 45° exists. Convenient tearing path 210 requires the severing of only a small region of weld metal 112 near the internal surfaces 113, 113′ of pipes 115, 115′. The narrowness of weld metal 112 at this location minimizes the resistance to tearing of the stronger weld metal 112 and promotes the occurrence of tearing path 210.

FIG. 11B illustrates a girth weld that connects first and second high strength steel pipes 115 and 115′ and has the following features in combination, according to this invention: (i) a composite HAZ 209 comprising at least one microstructural region at least 1 mm wide with a hardness value that is lower than the average hardness values of the base metal of steel pipes 115 and 115′ and the weld metal 112; (ii) one or more weld toes, e.g., 211, 212, 213, and 214, in contact with composite HAZ 209; and (iii) a weld geometry such that the angle between general weld fusion line 219 and the inside surface of the pipe wall 113 is less than 90°, all such that upon the approach of a crack tip (not shown in FIG. 11B) that is propagating through said first high strength steel pipe 115, a ring-off fracture will propagate around the circumference of said first high strength steel pipe 115 along said girth weld; i.e., the girth weld will experience a ductile tearing crack around its perimeter. As used herein, the “general weld fusion line” is a line that represents the general position of the weld fusion line, e.g., weld fusion line 219. As an example of noting the “general position” of a fusion line in an actual weld, a line 88 is marked in FIG. 8. Referring again to FIG. 11B, typically, the angle between the general weld fusion line 219 and the inside surface of the pipe wall 113 will approximate the angle of the beveled edge of steel pipe 115 to the inside surface of the pipe wall 113. For the purposes of this invention, the general position of any weld fusion line, such as line 88 (FIG. 8), need not be determined to a great degree of accuracy. Any person skilled in the art of welding engineering, and accustomed to examining weld cross sections, will be capable of suitably defining the general position of a fusion line to determine whether the angle between the general weld fusion line and inner pipe wall surface is less than 90°.

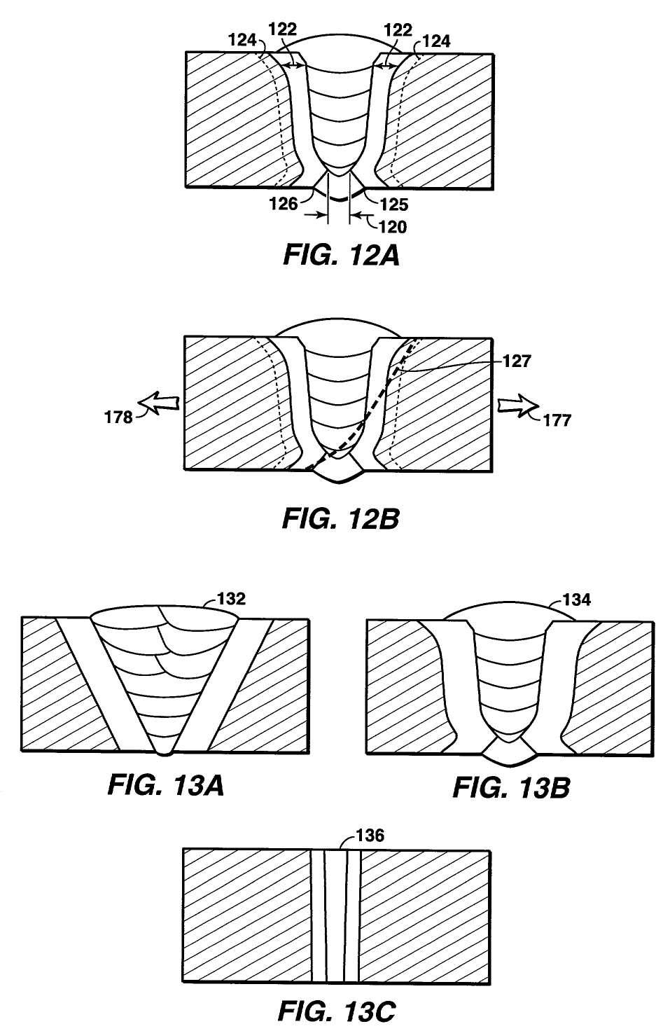

Another weld geometry of this invention that takes advantage of the narrowness of the weld metal near the internal pipe surface is a mechanized girth weld. Such a weld is shown in FIG. 8. Although the weld shown in FIG. 8 is of the CRC-type, the current invention is not limited to the CRC-type of mechanized weld. Any weld geometry that is, generally, wider at the cap than at the root will produce an inclined fracture path according to current invention. A schematic illustration of a cross section of the mechanized girth weld shown in FIG. 8 is provided in FIG. 12A, in which narrow weld metal region 120, etched HAZ 122, softened HAZ boundaries 124, and root weld toes 125 and 126 are identified. This weld geometry allows the “linking up” of several features of this invention that promote ring-off: soft HAZs, weld toes, and a narrow weld metal region near the internal pipe surface. FIG. 12B shows inclined fracture 127 of the weld illustrated in FIG. 12A. In FIG. 12B, the directions of principle strain 177 and 178 are shown.

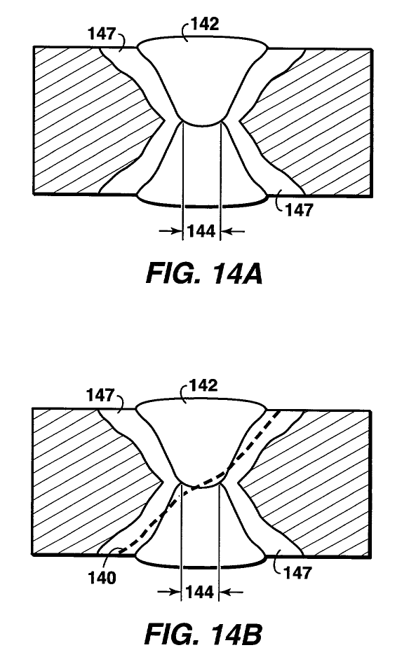

FIGS. 13A, 13B, and 13C show several girth weld geometries that are used in the pipeline industry. According to this invention, as the inclination of the HAZ changes from more inclined to less inclined, the ability of the weld to ring-off and arrest a crack is lessened. Therefore, from the standpoint of this invention, and creating an inclined fracture path, an electron beam weld 136 would be least likely to cause ring-off, as compared to a mechanized gas metal arc weld 134, and a manual girth weld (stick electrode) 132, which would be most likely to cause ring-off.

The engineer's decisions on how to produce a crack arresting girth weld for a particular pipeline will fall, generally, into two categories: (1) weld geometry, (2) welding heat input. The weld geometry affects the type and severity of stress concentrations and it controls the degree to which an inclined fracture path is produced. The heat input affects the degree of HAZ softening. The engineer will need to take a number of pipeline variables into consideration during the process of producing a crack arresting girth weld. Items like the pipe wall thickness, strength, microstructure, etc. will affect the choice of heat input so that a suitably soft HAZ is produced. The HAZ needs to be soft enough to provide a ring-off fracture tearing path, but strong enough for normal pipeline operations. These items will also need to be considered in combination with the welding process and bevel design. For a particular pipeline application, a person skilled in the art can use this disclosure to produce a crack arresting girth weld.

Another factor to consider in balancing girth weld design variables is that of weld metal strength. High weld metal strength (high overmatch, say, >about 20%) may protect the weld HAZ by constraining plastic flow near the weld. In addition, if the fracture path of least resistance includes some weld metal, a strongly overmatched weld will reduce the tendency for ring-off. Therefore, if a highly overmatched weld metal is used, the weld geometry and heat input should be selected to promote easier ring-off compared to the situation where a lower strength weld metal was used.

A good example of how different girth weld factors interact can be demonstrated by discussing the technique of “double-jointing”. Double-jointing is a common pipeline construction technique used to minimize the number of field welds. Typically, two 40 ft. pipes are joined to create one 80 ft. section. The welding is conducted “off-line” and the finished double-joints are transported to the field for pipeline construction. Often double jointing is conducted using the submerged arc welding (SAW) process. Because the two 40 ft. pipes can be rolled, a higher heat input can be used as compared to field girth welding where the pipes are stationary. SAW welding for double jointing can produce larger and softer HAZs than field girth welding. A schematic of a cross section of a double-joined weld produced by the SAW process is shown in FIG. 14A.

At first glance, the weld in FIG. 14A may not appear to provide a convenient inclined path for a ring-off fracture. However, these welds can be made to fail by ring-off, and a typical fracture path is shown in FIG. 14B. A significant amount of weld metal 142 near the center of the pipe wall at the location identified as 144 is severed by ductile tearing along fracture path 140. Although tearing through weld metal 142 at location 144 is relatively difficult compared to tearing in the HAZ 147, this difficulty typically is offset because the HAZs, such as HAZ 147, are softer than the average field weld. Using the current invention, a person skilled in the art can combine various degrees of HAZ softening with various welding techniques and geometries, to produce a variety of crack arresting girth welds.

Because it is impractical to discuss all possible combinations of pipe geometry, chemical composition, microstructure, welding techniques, etc. within the body of the current invention, it is obvious that the end user, a person skilled in the art, will have to tailor a crack arresting girth weld to suit a particular application. The girth welds must be strong enough for normal pipeline service, but “weak” enough to fail by ring-off during a running ductile fracture. Because of the number of interacting factors in producing a crack arresting girth weld, it is advisable to test candidate welds prior to application. Tests such as the West Jefferson method, or a full scale crack arrest test can be used to confirm the crack arresting capabilities of any particular girth weld.

Suitable Linepipe Steels

Linepipe steels suitable for use in linepipe to be welded according to the methods of this invention are described in U.S. Pat. No. 6,245,290 entitled “HIGH-TENSILE-STRENGTH STEEL AND METHOD OF MANUFACTURING THE SAME”, and in corresponding International Publication Number WO 98/38345; in U.S. Pat. No. 6,228,183 entitled “ULTRA HIGH STRENGTH, WELDABLE, BORON-CONTAINING STEELS WITH SUPERIOR TOUGHNESS”, and in corresponding International Publication Number WO 99/05336; in U.S. Pat. No. 6,224,689 entitled “ULTRA-HIGH STRENGTH, WELDABLE, ESSENTIALLY BORON-FREE STEELS WITH SUPERIOR TOUGHNESS”, and in corresponding International Publication WO 99/05334; in U.S. Pat. No. 6,248,191 entitled “METHOD FOR PRODUCING ULTRA-HIGH STRENGTH, WELDABLE STEELS WITH SUPERIOR TOUGHNESS”, and in corresponding International Publication WO 99/05328; and in U.S. Pat. No. 6,264,760 entitled “ULTRA-HIGH STRENGTH, WELDABLE STEELS WITH EXCELLENT ULTRA-LOW TEMPERATURE TOUGHNESS”, and in corresponding International Publication WO 99/05335 (U.S. Pat. Nos. 6,245,290, 6,228,183, 6,224,689, 6,248,191, and 6,264,760, are referred to collectively herein as the “Steel Patent Applications”). The Steel Patent Applications are hereby incorporated herein by reference. Other suitable linepipe high strength linepipe steels may exist or be developed hereafter. The steels in the Steel Patent Applications are discussed only for the purpose of providing examples. The welding methods of this invention are in no way limited to being used on pipelines constructed from the linepipe steels discussed herein.

Although this invention is well suited for the joining of high strength steel linepipe, it is not limited thereto; rather, this invention is suitable for the joining of any steels having a yield strength of about 550 MPa (80 ksi) or greater. Additionally, while the present invention has been described in terms of one or more preferred embodiments, it is to be understood that other modifications may be made without departing from the scope of the invention, which is set forth in the claims below.

Glossary of Terms

general weld fusion line: a line that represents the general position of the interface between the weld metal and the base metal;

HAZ: heat-affected zone;

heat-affected zone: the region of base metal directly adjacent to the weld metal whose metallurgical structure has been altered by the heat from welding;

kJ: kilojoule; and

soft HAZ: a HAZ that contains at least one macroscopic region having a hardness value that is lower than the average hardness value of the base metal on one side of the HAZ and is lower than the average hardness value of the weld metal on the other side of the HAZ, each of said hardness values being measured by the same technique; typically the macroscopic region is at least 1 mm wide.

We claim:

1. In a pipeline constructed from two or more high strength steel pipes, a girth weld joining a first high strength steel pipe to a second high strength steel pipe, which girth weld is designed to prevent the propagation of a running ductile crack from said first high strength steel pipe into said second high strength steel pipe, said girth weld comprising:
(i) a weld metal,
(ii) a soft heat-affected zone between said weld metal and said first high strength steel pipe,
(iii) one or more weld toes in contact with said soft heat-affected zone,
(iv) a general weld fusion line, and
(v) a cross section geometry such that the angle described by said general weld fusion line and the internal surface of said first high strength steel pipe is less than 90°,
all such that as a crack propagating through said first high strength steel pipe toward said girth weld enters the immediate region of said girth weld, said girth weld will crack around its perimeter, thus preventing propagation of said crack into said second high strength steel pipe.

2. In a pipeline constructed from two or more high strength steel pipes, a girth weld joining a first high strength steel pipe to a second high strength steel pipe, which girth weld is designed to prevent the propagation of a running ductile crack from said first high strength steel pipe into said second high strength steel pipe, said girth weld comprising:
(i) a weld metal,
(ii) a first soft heat-affected zone between said weld metal and said first high strength steel pipe and a second soft heat-affected zone between said weld metal and said second high strength steel pipe,
(iii) one or more weld toes in contact with each of said first and second soft heat-affected zones,
(iv) a first general weld fusion line associated with said first soft heat-affected zone and a second general weld fusion line associated with said second soft heat-affected zone, and
(v) a cross section geometry such that a first angle described by said first general weld fusion line and the internal surface of said first high strength steel pipe is less than 90° and a second angle described by said second general weld fusion line and the internal surface of said second high strength steel pipe is less than 90°,
all such that as a running ductile crack propagating through said first high strength steel pipe toward said girth weld enters the immediate region of said girth weld, said girth weld will experience a ductile tearing crack around its perimeter, thus preventing propagation of said crack into said second high strength steel pipe.

3. A method for minimizing the distance of propagation of a crack through a pipeline constructed from two or more high strength steel pipes, said method comprising:
joining a first high strength steel pipe to a second high strength steel pipe with a girth weld that comprises
(i) a weld metal,
(ii) a soft heat-affected zone between said weld metal and said first high strength steel pipe,
(iii) one or more weld toes in contact with said soft heat-affected zone,
(iv) a general weld fusion line, and
(v) a cross section geometry such that the angle described by said general weld fusion line and the internal surface of said first high strength steel pipe is less than 90°,
all such that as a crack propagating through said first high strength steel pipe toward said girth weld enters the immediate region of said girth weld, said girth weld will crack around its perimeter, thus preventing propagation of said crack into said second high strength steel pipe.

4. A method for minimizing the distance of propagation of a running ductile crack through a pipeline constructed from two or more high strength steel pipes, said method comprising:
joining a first high strength steel pipe to a second high strength steel pipe with a girth weld that comprises
(i) a weld metal,
(ii) a first soft heat-affected zone between said weld metal and said first high strength steel pipe and a second soft heat-affected zone between said weld metal and said second high strength steel pipe,
(iii) one or more weld toes in contact with each of said first and second soft heat-affected zones,
(iv) a first general weld fusion line associated with said first soft heat-affected zone and a second general weld fusion line associated with said second soft heat-affected zone, and
(v) a cross section geometry such that a first angle described by said first general weld fusion line and the internal surface of said first high strength steel pipe is less than 90° and a second angle described by said second general weld fusion line and the internal surface of said second high strength steel pipe is less than 90°,
all such that as a running ductile crack propagating through said first high strength steel pipe toward said girth weld enters the immediate region of said girth weld, said girth weld will experience a ductile tearing crack around its perimeter, thus preventing propagation of said crack into said second high strength steel pipe.

5. A method of welding to join a first high strength steel pipe to a second high strength steel pipe, said method comprising producing (i) a weld metal and a soft heat-affected zone between said weld metal and said first high strength steel pipe, (ii) one or more weld toes in contact with said soft heat-affected zone, and (iii) a cross section geometry such that the angle described by a general weld fusion line and the internal surface of said first high strength steel pipe is less than 90°, all such that as a crack propagating through said first high strength steel pipe toward said girth weld enters the immediate region of said girth weld, said girth weld will crack around its perimeter, thus preventing propagation of said crack into said second high strength steel pipe.

6. A method of welding to join a first high strength steel pipe to a second high strength steel pipe, said method comprising producing (i) a weld metal, a first soft heat-affected zone between said weld metal and said first high strength steel pipe, and a second soft heat-affected zone between said weld metal and said second high strength steel pipe, (ii) one or more weld toes in contact with each of said first and second soft heat-affected zones, and (iii) a cross section geometry such that a first angle described by a first general weld fusion line and the internal surface of said first high strength steel pipe is less than 90° and a second angle described by a second general weld fusion line and the internal surface of said second high strength steel pipe is less than 90°, all such that as a running ductile crack propagating through said first high strength steel pipe toward said girth weld enters the immediate region of said girth weld, said girth weld will experience a ductile tearing crack around its perimeter, thus preventing propagation of said crack into said second high strength steel pipe.
